(19) United States
(12) Patent Application Publication
(10) Pub. No.: US 2007/0137332 A1
(43) Pub. Date: Jun. 21, 2007

(54) FAST-MOVING SCREW ASSEMBLY

(76) Inventors: MICHAEL KLEIN, Grafenrheinfeld (DE); Roland Greubel, Ramsthal (DE)

Correspondence Address: STRIKER, STRIKER & STENBY, 103 EAST NECK ROAD, HUNTINGTON, NY, 11743, US

(21) Appl. No.: 11/557,630

(22) Filed: Nov. 8, 2006

(30) Foreign Application Priority Data
Nov. 11, 2005 (DE) 10 2005 054 290.5

(51) Int. Cl. F16H 27/02

(52) U.S. Cl. 74/89.23

(57) ABSTRACT

In a method for operating a screw assembly, having a spindle, which is rotatably supported on at least one end, and a nut, which is drivable by the spindle in a forward-feed direction, the nut being braced transversely to the forward-feed direction on a primary subassembly, and the spindle rpm is selected as a function of the position of the nut such that this rpm is just below a position-dependent limit rpm, in order to attain the shortest possible travel time.

### CROSS-REFERENCE TO A RELATED APPLIACTION

The invention described and claimed hereinbelow is also described in German Patent Application DE 10 2005 054 290.5 filed on Nov. 11, 2005. This German Patent Application, whose subject matter is incorporated here by reference, provides the basis for a claim of priority of invention under 35 U.S.C. 119(a)-(d).

### BACKGROUND OF THE INVENTION

The invention relates to a method for operating a screw assembly and to an apparatus for performing the method.

One such method is known for instance from German Patent Disclosure DE 198 21 763 A1. In this reference, the problems of the bending-critical rotary rpm, namely if the effect that the screw assembly on reaching this rpm experiences bending oscillations by which it can be damaged or destroyed, is described in conjunction with FIG. 12. The bending-critical rpm is fundamentally dependent on the unbraced length of a rotating shaft. In a screw assembly in which the nut is braced transversely to the direction of motion, this length is dependent on the nut position along the spindle.

The bending-critical rpm is substantially higher if the nut is in the center of the spindle than when it is in the vicinity of one end of the spindle. DE 198 21 763 A1 describes as prior art a method for operating a screw assembly (column 10, lines 33 ff) in which a constant limit rpm for the spindle is determined in accordance with the least favorable position of the nut. Particularly with long spindles, this rpm is very low, which results in very long travel times of the nut. For solving this problem, DE 198 21 763 A1 proposes intermediate bearers for the spindle by which the bending-critical rpm itself is increased.

### SUMMARY OF THE INVENTION

Accordingly, it is an object of the present invention to provide a method for operating the screw assembly as well as an apparatus for performing the method, which are further improvements of the corresponding methods and apparatuses.

More particularly, It is an object of the present invention to provide a method for operating a screw assembly and an apparatus for performing the method, in which a short travel time is attained in a simple way.

In keeping with these objects and with others which will become apparent hereinafter, one feature of the present invention resides, briefly stated, in a method for operating a screw assembly, comprising the steps of supporting a spindle rotatably on at least one end; driving a nut by the spindle in a forward-feed direction; bracing the nut transversely to the forward-feed direction on a primary subassembly; and selecting an rpm (n) of the spindle as a function of a position of the nut such that this rpm is just below a position-dependent limit rpm.

Because of the choice of the spindle rpm as a function of the position of the nut, specifically always just below the position-dependent limit rpm, preferably the bending-critical rpm, higher spindle speeds can be attained than in the prior art. As a result, the travel times of the nut are shortened, without the possibility of damage to the screw assembly from bending oscillations.

In the concrete selection of a spindle rpm just below the limit rpm, the fact must be taken into account that the bending-critical rpm is the rpm at which the maximum bending oscillations occur at the spindle. The term is also called the resonance point. Such oscillations also, however, occur in neighboring rpm ranges, although in attenuated form. It has been found that if the spindle rpm is selected from a range of between 60% and 90% of the limit rpm, preferably between 70% and 80% of the limit rpm, no oscillations that could damage the screw assembly occur. This is true only as long as the limit rpm is definitively the critical rpm of the spindle.

The limit rpm may optionally be the least rpm from a group of limit speeds which includes
the position-dependent critical rpm of the spindle,
the maximum allowable relative rpm between the spindle and the nut, and
the maximum allowable rpm of the spindle bearing.

It has been found that the bending-critical rpm, in relatively short spindles in the region of the center of the spindle, is so high that other limits occur that force a reduction in the rpm if damage to the screw assembly is to be averted. Particularly in roller bearing screw assemblies, there is a maximum allowable relative rpm between the spindle and the nut. This is due to the fact that the roller bodies, revolving in endless loops, cannot be moved at arbitrarily high speed by the deflectors. Because of the short deflection radii, centrifugal forces would occur, which would destroy the deflectors. Radial roller bearings typically used for supporting the spindle also have a maximum allowable rpm, but only in rare cases is it below the two limit speeds described above.

The spindle can also be driven by a motor, preferably an electric motor. A motor, too, typically has a maximum allowable rpm. The result, besides the ratio of a gear, optionally located between the motor and the spindle, is a maximum spindle rpm, which may be included in the group with limit speeds.

The limit speeds, along with the critical rpm of the spindle, can typically be utilized to the extent of 100%. In this connection, see the information stated in catalogs from the manufacturers in question.

The method of the invention can be performed in a simple way with an apparatus which includes the screw assembly described at the outset as well as
position determining means for the nut,
allocation means, in which an association between the nut position and the spindle rpm is stored in memory and which performs the method of the invention, and
rpm adjusting means for the spindle.

The position determining means may for instance be a linear travel measuring system, which measures the position of the nut. However, a rotary transducer may also be provided, whose measurement values are converted into a nut position by a calculation unit, taking the spindle pitch into account.

The rpm adjusting means for the spindle is preferably an electric motor, which is provided with a speed controller or governor. The controller or governor is supplied with the outputs from the allocation means. The motor may optionally be connected in terms of its drive to the spindle via a gear. If a synchronous motor with an rpm controller is used, the rpm information available there can be used as an input parameter for the position determining means.

The allocation device may for instance be a calculating device, which calculates the spindle rpm based on the output of the position determining means, using the known formulas for the critical rpm. In this case, the definitive characteristics of the method of the invention are stored in the memory in the form of formulas.

However, it may also be provided that the allocation means include a table, which associates a spindle rpm with individual predetermined nut positions, and calculation means, which linearly interpolate the spindle rpm between the predetermined nut positions. This embodiment has the advantage that it is easy to perform using universal machine controllers, since complicated calculations do not have to be made.

Moreover, a memory-programmable controller may be provided, which has a drive command that drives the nut with the aid of the allocation means. For instance, in a known controller of a machine tool, a rapid-feed command may be provided, which in accordance with the method of the invention moves a machine sled that is driven by a screw assembly. A rapid-feed command typically has the task of moving the machine sled from its current position to a target position as fast as possible. Such a command can be used in a workpiece manufacturing program that is created by the machine user and is stored in the memory of the controller. The proposed embodiment makes it simpler for the machine user to use the method of the invention, since the rpm curve according to the invention need not be approached at a constant travel speed by means of many individual, known rapid-feed commands.

It should also be noted that the screw assembly is preferably a prestressed ball screw assembly. As a result, the spindle is braced without play by the nut. It is thus assured that the nut can perform its function as an additional bearing point for the spindle reliably, so as to avoid bending oscillations. Above all, small oscillations within the course of the play are avoided; if the embodiment were different, they could occur and could also lead to damage of the screw assembly.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a rough schematic illustration of an apparatus according to the invention; and

FIG. 2 is a graph showing various curves in which the spindle speeds n are plotted over the nut position x.

### DESCRIPTION OF THE PREFERRED EMBODIMENTS

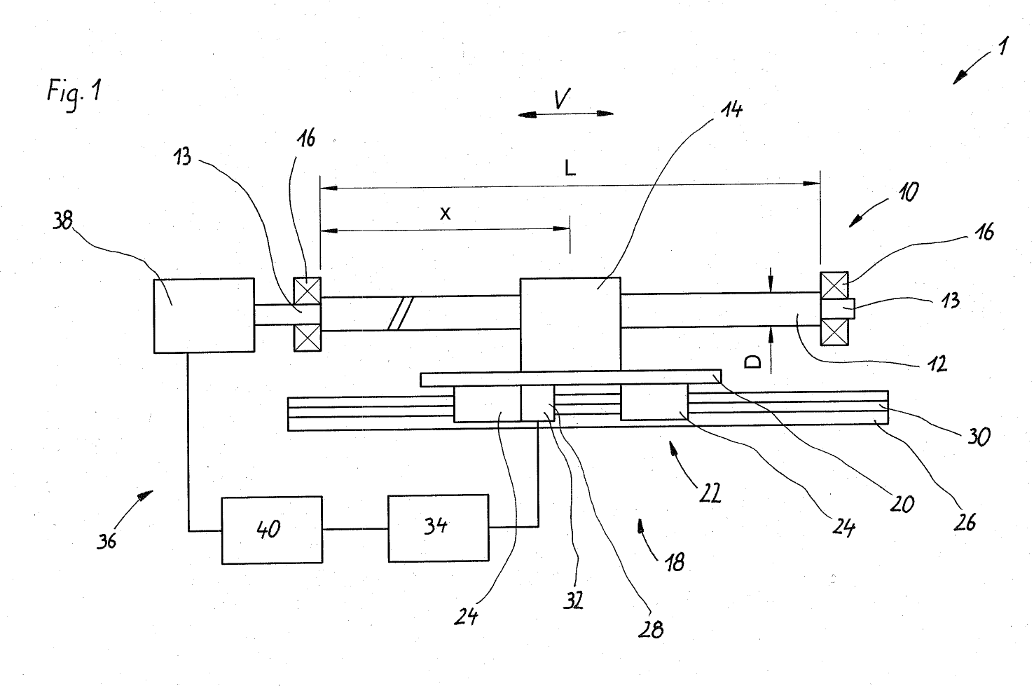

In FIG. 1, an apparatus according to the invention, having a screw assembly 10, is identified overall by reference numeral 1. The screw assembly 10, whose forward- feed direction is marked V, includes a spindle 12 and a nut 14. The screw assembly 10 is a ball screw assembly with clockwise motion, having the following specifications:

| | | |
|---|---|---|
| Spindle diameter (D): | 50 | mm |
| Pitch: | 40 | mm |
| Ball diameter: | 6.5 | mm |
| Spindle length (L): | 5000 | mm |

| | |
|---|---|
| Prestressing category: | 3% of the dynamic load- |
| | bearing coefficient |

The spindle is rotatably supported on both ends 13 by means of bearings 16, namely radial-fluted ball bearings. The two bearings 16 are embodied as fixed bearings; that is, neither of the two bearings 16 allows any motion of the spindle ends 13 in the forward-feed direction V.

The nut 14 is braced transversely to the forward-feed direction V on a primary subassembly 18 formed by a table 20, which is supported on a linear roller bearing 22 so as to be movable in the forward-feed direction V. The linear roller bearing 22 includes a plurality of guide carriages 24, which are braced on a guide rail 26 via endlessly revolving rows of roller bodies, not shown.

A position determining means 28 for determining the position x of the nut 14 is mounted on the linear roller bearing 22. The position determining means 28 includes a material measure 30, which is mounted on the guide rail 26, and an associated scanner 32, which is located on one of the guide carriages 24.

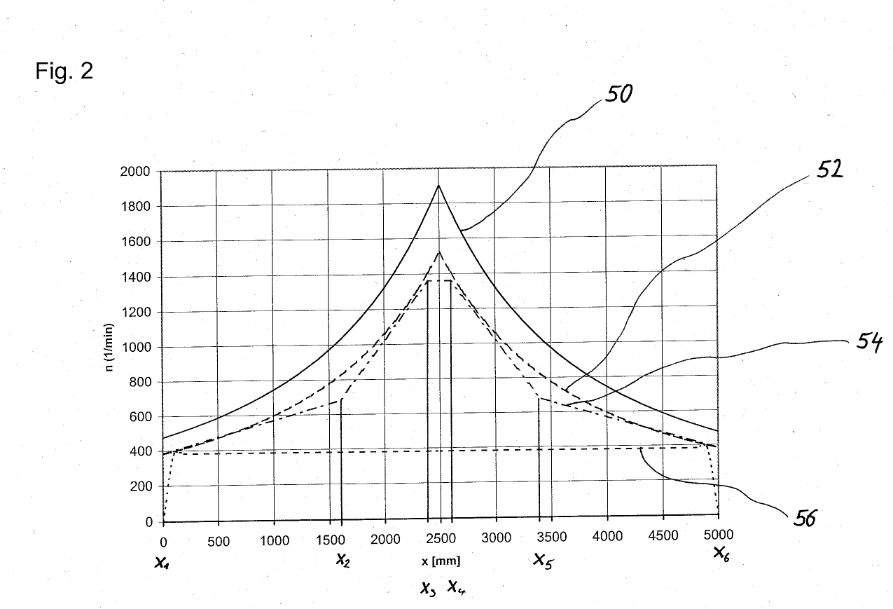

The nut position x is sent onward to allocation means 34, in which an association between the nut position x and the spindle rpm n is stored in memory and performs the method of the invention. The allocation means 34 include a table in which fixed spindle speeds, which can be found from the curve 54 in FIG. 2, are associated with individual predetermined nut positions x₁ through x₆. Calculation means are also provided, which linearly interpolate the spindle rpm between the predetermined nut positions x₁ through x₆, resulting in the association represented by curve 54 in FIG. 2.

The spindle rpm thus ascertained is sent onward to rpm adjusting means 36, which include a motor 38 and an associated controller 40. The motor 38 is connected in terms of drive to one end 13 of the spindle.

In FIG. 2, various curves for the spindle rpm ii are plotted in min⁻¹ over the nut position x in millimeters for the screw assembly described above. The curve 50 represents the critical rpm of the spindle (12). It was found in accordance with the information in the catalog entitled “Rexroth-Kugelgewindetriebe—Endenlagerungen und Mutergehäuse” [Rexroth Ball Screw Assemblies—End Bearings and Nut Housings], Order No. R31 ODE 3001, issue dated November 2004, page 120. The maximum critical rpm is 1900 min⁻¹ and is thus less than the maximum allowable relative rpm between the nut and the spindle, which is 3000 min⁻. The definitive limit rpm over the entire spindle length is accordingly the critical rpm.

In curve 52, the spindle rpm that corresponds to 80% of the critical rpm is plotted. If this curve is stored in memory in allocation means (34), what is obtained is the least possible travel time at which it is reliably assured that the ball screw assembly (10) will not be damaged.

The curve 54 was approximated from below to the curve 52 by linear interpolation. When the curve 54, as described above, is used, it is likewise reliably precluded that the ball screw assembly will become damaged. When this curve is used, the travel time for moving the nut over the entire spindle length is 11.6 seconds.

For comparison, in curve 56, the rpm course is plotted for the method from the prior art as described at the outset. In this case, the travel time is 19.7 seconds. It is thus approximately 70% longer than the travel time for the method of the invention. This time saving is achieved without making complicated mechanical changes to the screw assembly.

It will be understood that each of the elements described above, or two or more together, may also find a useful application in other types of methods and constructions differing from the types described above.

While the invention has been illustrated and described as embodied in a fast-moving screw assembly, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method for operating a screw assembly, comprising the steps of supporting a spindle rotatably on at least one end; driving a nut by the spindle in a forward-feed direction; bracing the nut transversely to the forward-feed direction on a primary subassembly; and selecting an rpm of the spindle as a function of a position of the nut such that this rpm is just below a position-dependent limit rpm.

2. A method as defined in claim 1, wherein said selecting includes selecting the limit rpm as a lowest rpm of a group of limit speeds which contains a position-dependent critical rpm of the spindle.

3. A method as defined in claim 2; and further comprising including in the group of limit speeds a maximum allowable relative rpm between the spindle and the nut, and a maximum allowable rpm of a spindle bearing.

4. A method as defined in claim 2; and further comprising driving the spindle by a motor; and including in the group of limit speeds a maximum allowable spindle rpm that results from a maximum allowable motor rpm.

5. A method as defined in claim 1; and further comprising selecting the spindle rpm in a range of between 60% and 90% of the limit rpm, if a definite limit rpm is a critical rpm of the spindle.

6. A method as defined in claim 5; and further comprising selecting the spindle rpm in a range between 70% and 80% of the limit rpm.

7. An apparatus, comprising a screw assembly including a spindle which is rotatably supported on at least one end, a nut which is drivable by said spindle in a forward-feed direction and is braced transversely to the forward-feed direction on a primary subassembly, wherein a spindle rpm is selected as a function of a position of said nut such that this rpm is just below a position-dependent limit rpm.

8. An apparatus as defined in claim 7; and further comprising position determining means for said nut; allocation means, in which an association between the nut position and the spindle rpm is stored in memory; and rpm adjusting means for said spindle.

9. An apparatus as defined in claim 8, wherein said allocation means include a table, which associates a spindle rpm with individual predetermined nut positions, and calculation means which linearly interpolate the spindle rpm between the predetermined nut positions.

10. An apparatus as defined in claim 7; and further comprising a memory-programmable controller, which has a drive command that drives said nut with said allocation means.

11. An apparatus as defined in claim 7, wherein said screw assembly is a pre-stressed roller bearing screw assembly.
